(19) United States
(12) Patent Application Publication
(10) Pub. No.: US 2011/0234462 A1
(43) Pub. Date: Sep. 29, 2011

(54) PORTABLE RADIO APPARATUS

(75) Inventors: Kouta Aoki, Kanagawa (JP); Takahiro Ochi, Miyagi (JP); Kenshi Horihata, Kanagawa (JP); Shigeaki Sakurazawa, Kanagawa (JP); Yoshihiro Kanasaki, Miyagi (JP)

(73) Assignee: PANASONIC CORPORATION, Osaka (JP)

(21) Appl. No.: 13/126,142

(22) PCT Filed: Oct. 23, 2009
(86) PCT No.: PCT/JP2009/005612

§ 371 Date: Apr. 26, 2011

(30) Foreign Application Priority Data
Oct. 30, 2008 (JP) 2008-280231

(51) Int. Cl. H01Q 1/24

(52) U.S. Cl. 343/702

(57) ABSTRACT

A portable radio apparatus includes: a first circuit board disposed within a first housing; a second circuit board disposed within a second housing; a third housing disposed between the first housing and the second housing; a first hinge part rotatably coupling the first and third housings; an electrically conductive and hollow second hinge part rotatably coupling the second housing and the third housing; a connection cable inserted in the second hinge part and electrically connecting the first circuit board and the second circuit board; and an antenna element disposed within the third housing. The antenna element and the second hinge part are connected such that the second hinge part functions as a ground of the antenna element. The portable radio apparatus further includes an electrically conductive connection member electrically connecting the ground of the antenna element and a ground of the second circuit board.

### TECHNICAL FIELD

The present invention relates to a portable radio apparatus having an antenna mounted in a foldable housing.

### BACKGROUND ART

A portable radio apparatus, such as a portable telephone terminal, having a structure including two separated housings coupled through a hinge part so as to be open and close or to be foldable is in widespread use. Some of the portable radio apparatuses of this type include an antenna of a housing dipole type in which the housing per se or a circuit board mounted in the housing functions as an antenna.

As the portable radio apparatus in which the housing functions as the antenna, for example, Patent Document 1 discloses a portable radio apparatus including an antenna element provided in a first housing, an electrically conductive hinge part which rotatably couples the first housing to a second housing and which is electrically connected to the antenna element, and a power feeding portion for feeding a power to the hinge part from a circuit board disposed in the second housing, wherein the first housing functions as the antenna element.

FIG. 9 is a diagram illustrating a configuration example of the portable radio apparatus having the housing dipole antenna. A left diagram is viewed from a back side, and a right diagram is viewed from a right side of the housing back side. In this example, there are provided a first housing 101, a second housing 102, and a hinge part 103 which rotatably couples the housings 101, 201 and which is made of an electrically conductive metal. The first housing 101 includes a first circuit board 104, and the second housing 102 includes a second circuit board 105. The hinge part 103 is housed in one of the first housing 101 and the second housing 102. An antenna element 106 is disposed at a given distance from the hinge part 103 in the vicinity of the hinge part 103 and is connected through a power feeding portion 107 to a matching circuit 108 and a radio circuit 109 which are mounted on the second circuit board 105 disposed within the second housing 102. The first circuit board 104 and the second circuit board 105 are connected by a connection cable 110 for input and output of signals and ground connection. In this configuration, a power is fed from the radio circuit 109 to the antenna element 106 by the power feeding portion 107, the antenna element 106 is capacitively coupled to the hinge part 103, and the hinge part 103 is capacitively coupled to the first circuit board 104 disposed within the first housing 101 whereby the hinge part 103 and the first circuit board 104 function as an antenna element in a state where the housing is opened to perform dipole operation. With the configuration of this housing dipole antenna, since a large antenna volume can be ensured, the high performance and wide band of the antenna performance can be facilitated. In the housing dipole antenna configuration, because the connection cable 110 is connected to the ground, it is preferable to arrange the connection cable 110 at a given distance from the power feeding portion.

### RELATED ART DOCUMENTS

### Patent Documents

Patent Document 1: JP-A-2005-6096
Patent Document 2: JP-B-4064443

### SUMMARY OF THE INVENTION

### Problem to be Solved by the Invention

The portable radio apparatus is large in the limitations of the arrangement and space of the antenna from the viewpoints of the size reduction and design of the housing and the antenna performance. In particular, in the housing dipole antenna configuration, to house the hinge part made of the electrically conductive metal and the antenna element in the same housing makes it difficult to reduce the size of the housing. Therefore, for example, when the hinge part is arranged in the first housing 101, the antenna element is arranged in the second housing 102. Also, as disclosed in Patent Document 2, there has been proposed a portable radio apparatus with a double-hinged structure including two hinge parts, and rotatable by a first hinge part having a rotation axis along a lateral direction of the housing so as to open and close in a longitudinal direction of the housing, and rotatable by a second hinge part having a rotation axis along the longitudinal direction of the housing so as to open and close in the lateral direction of the housing.

As one example, a case in which the configuration of FIG. 9 is modified into the double-hinged structure and in which the arrangements of the hinge part and the antenna element are replaced with each other is considered. FIG. 10(A) illustrates a configuration diagram. A left diagram is viewed from a back side, and a right diagram is viewed from a right side of the housing back side. A third housing 111 having the first hinge part 103 and a second hinge part 112 including an electrically conductive member is disposed between the first housing 101 and the second housing 102, and the antenna element 106 is disposed within the third housing 111. The second hinge part 112 has an axis perpendicular to an axis of the first hinge part so that the first housing can open and close in the lateral direction of the housing with respect to the second housing and the third housing. The antenna element 106 is connected to the power feeding portion 107, and connected to the radio circuit 109 mounted on the second circuit board through the matching circuit 108 and an RF cable 114. The matching circuit 108 needs to be disposed in the vicinity of the antenna element 106 and the power feeding portion 107, and is disposed within the third housing. The ground of the matching circuit 108 is connected to the ground of the first circuit board through a connection member 113 and the second hinge part 112. The connection cable 110 penetrates through the inside of the second hinge part, and connects the grounds of the first circuit board and the second circuit board.

FIG. 10(B) shows the configuration of FIG. 10(A) in a state in which the first housing is opened in the lateral direction of the housing with the second hinge part as an axis. A first housing 101b that is an end of the second hinge part side in the lateral direction of the housing is close to the second housing 102. However, a first housing 101a that is an end opposite to the second hinge part in the lateral direction of the housing is spaced from the second housing. Because of the limit of the structure, the connection cable 110 needs to penetrate through the inside of the second hinge part, which couples the first housing and the third housing, in the vicinity of the first housing 101b. Also, because of the size reduction of the housing, the first hinge part and the second hinge part are arranged at both ends of the housing in the lateral direction of the housing. Because of the limit of this structure, the RF cable 114 and the connection cable 110 need to be disposed in a limited space between the first hinge part and the second hinge part. Further, since an improvement in the antenna performance is expected more by increasing a volume of the antenna element and decreasing a length of the RF cable, and since wiring of the RF cable is difficult, there is a limit that the power feeding portion 107 is arranged in the vicinity of the second hinge part 112 and the connection cable 110.

By the above-mentioned structural limit, it is difficult to apply the conventional housing dipole antenna configuration, and the power feeding portion 107 is disposed in the vicinity of the second hinge part 112 and the ground of the connection cable 110. Therefore, there arises such a problem that the performance is deteriorated. Also, because the connection cable 110 having an impedance different from that of the second hinge part is inserted into the second hinge part which is the ground of the matching circuit, the respective currents interfere with each other, which results in a problem of deterioration of the antenna performance.

The present invention has been made in view of the above circumferences, and an object thereof is to provide a portable radio apparatus that can improve the antenna performance in a case where the portable radio apparatus is configured such that a housing has a double-hinged structure, a connection cable is inserted into a second hinge functioning as a ground of an antenna element, and a power feeding portion is arranged in the vicinity of the second hinge part and the connection cable.

### Means for Solving the Problem

According to the present invention, there is provided a portable radio apparatus including: a first housing; a first circuit board disposed within the first housing; a second housing; a second circuit board disposed within the second housing; a radio circuit disposed on one of the first circuit board and the second circuit board; a third housing disposed between the first housing and the second housing; a first hinge part which couples the first housing and the third housing so as to be rotatable about a first rotation axis, and which includes an electrically conductive member; a second hinge part which couples the second housing and the third housing so as to be rotatable about a second rotation axis perpendicular to the first rotation axis, which comprises an electrically conductive member, and which is hollow; a connection cable which is inserted into the second hinge part, and which electrically connects the first circuit board and the second circuit board; and an antenna element disposed within the third housing, wherein the antenna element and the second hinge part are connected such that the second hinge part functions as a ground of the antenna element, and wherein the portable radio apparatus further comprises an electrically conductive connection member electrically connecting the ground of the antenna element and a ground of the second circuit board.

In the above configuration, there is a structural limit that the arrangement of the components is limited, for example, the antenna element is arranged within the third housing. Further, the second hinge functions as the ground of the antenna element, the connection cable connecting the first circuit board disposed within the first housing and the second circuit board disposed within the second housing is inserted into the second hinge part, the second hinge part and the connection cable are close to each other, and the respective currents affect each other. With this configuration, the electrically conductive connection member connects the second hinge part and the second circuit board whereby the current flows in a path from the second hinge part to the second circuit board. Consequently, the current concentrated in the vicinity of the second hinge part is dispersed, an interinfluence between the currents flowing in the second hinge part and the connection cable can be reduced, and the antenna performance can be improved. Further, by allowing a current to flow in a direction toward the second circuit board located apart from a user's head in use, an SAR is improved.

According to the present invention, in the above portable radio apparatus, the electrically conductive connection member has a linear-shaped member and is disposed close to and along at least a part of the connection cable.

With the above configuration, the connection cable is capacitively coupled to the electrically conductive connection member, a part of the current flowing in the connection cable is allowed to flow in the electrically conductive connection member, the ground potential of the connection cable and the potential of the second hinge part can be brought close to each other, and a reversed phase current of the current flowing into the first circuit board and the current flowing in the connection cable can be suppressed.

According to the present invention, in the above portable radio apparatus, the electrically conductive connection member covers at least a periphery of a part of the connection cable.

With the above configuration, a shield part of the electrically conductive connection member covers at least the partial periphery of the connection cable whereby the capacitive coupling of the connection cable and the electrically conductive connection member is enhanced, and the current flowing in the connection cable is liable to more flow into the electrically conductive connection member. Also, because the periphery of the connection cable is covered with the shield part, the effect of suppressing unnecessary radiation from the connection cable can be enhanced.

Also, according to the present invention, in the above portable radio apparatus, the electrically conductive connection member is grounded to the ground of the second circuit board through an impedance element.

With the above configuration, the impedance of the electrically conductive connection member can be adjusted to be optimized according to a frequency.

### Advantages of the Invention

The present invention can provide the portable radio apparatus that can improve the antenna performance in a case where the portable radio apparatus is configured such that the housing is of the double-hinged structure, the connection cable is inserted into the second hinge functioning as the ground of the antenna element, and the power feeding portion is arranged in the vicinity of the second hinge part and the connection cable.

### BRIEF DESCRIPTION OF THE DRAWINGS

FIGS. 1(A) and 1(B) are diagrams illustrating configuration examples of a portable radio apparatus having a folding housing.

FIGS. 2(A) and 2(B) are diagrams schematically illustrating currents in operation in the configuration examples of the portable radio apparatus illustrated in FIGS. 1(A) and 1(B).

FIG. 3 is a diagram illustrating a configuration of a portable radio apparatus according to an embodiment of the present invention.

FIG. 4 is a diagram illustrating a main configuration of the portable radio apparatus according to this embodiment.

FIG. 5 is a diagram schematically illustrating currents in operation in the portable radio apparatus according to this embodiment.

FIG. 6 is a diagram illustrating a configuration of a portable radio apparatus according to a second embodiment of the present invention.

FIGS. 7(A) and 7(B) are diagrams illustrating a measurement example of an SAR in a comparative example in which no electrically conductive connection member is provided.

FIGS. 8(A) and 8(B) are diagrams illustrating the measurement example of the SAR in this embodiment in which an electrically conductive connection member is provided.

FIG. 9 is a diagram illustrating a configuration example of a portable radio apparatus having a housing dipole antenna.

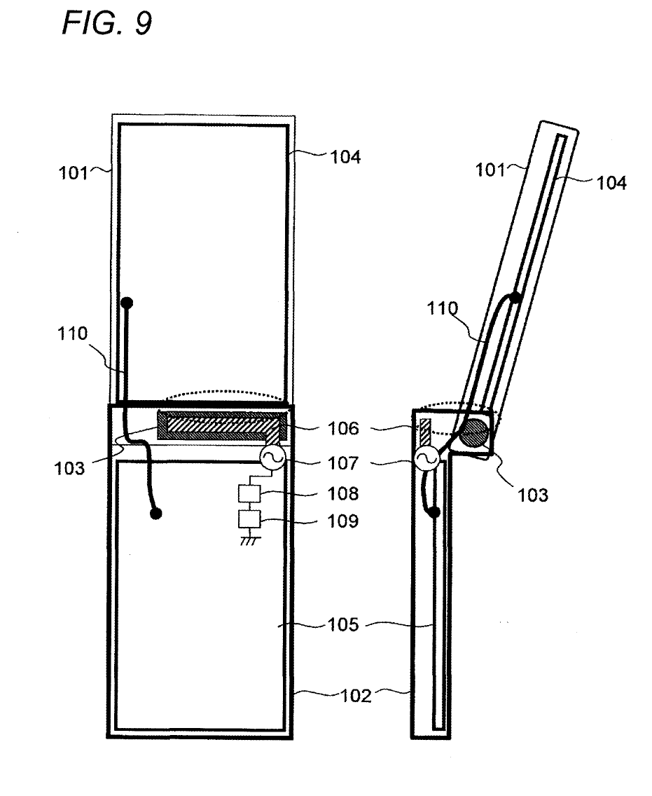

FIGS. 10(A) and 10(B) are diagrams illustrating an example in which a configuration of the portable radio apparatus in FIG. 9 is modified.

### MODE FOR CARRYING OUT THE INVENTION

The following embodiments show configuration examples of a portable radio apparatus which is applied to a portable terminal device having a foldable housing, such as a cellular phone. The present invention is applicable to various portable radio apparatuses that can be carried by a user.

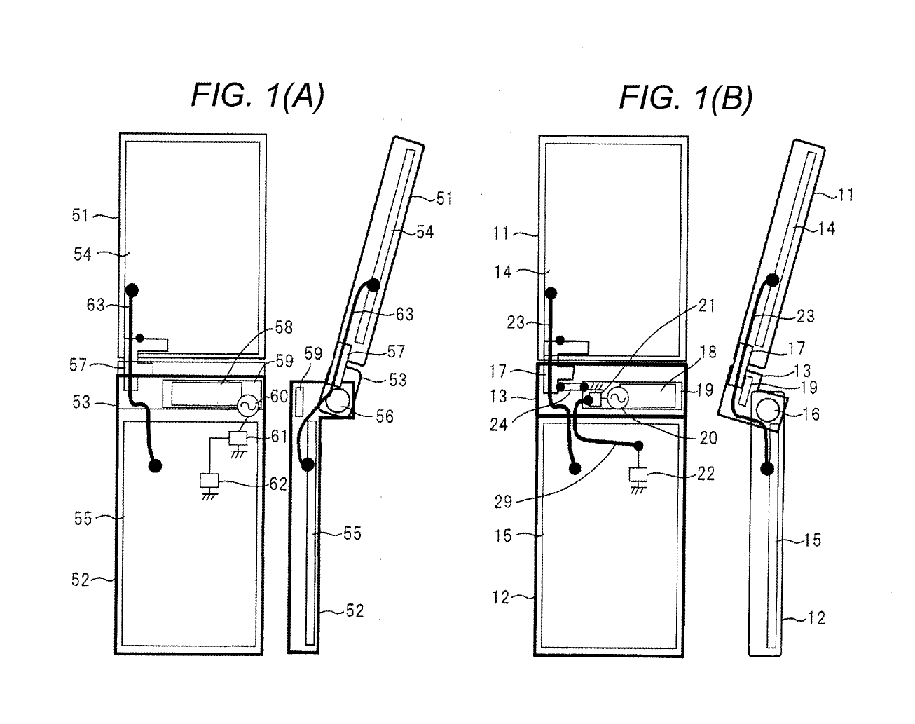

First, a configuration of a folding housing and an arrangement of a corresponding antenna are described. FIG. 1 is a diagram illustrating configuration examples of a portable radio apparatus having a folding housing, in which FIG. 1(A) illustrates a first example, and FIG. 1(B) illustrates a second example. In each of FIGS. 1(A) and 1(B), a left side is a diagram of the housing viewed from a back side, and a right side is a diagram viewed from a right side of the back side, and each diagram schematically illustrates the components inside the housing in a viewable manner.

The first example illustrated in FIG. 1(A) has a housing of a general double-hinged structure. In the first example, a third housing 53 having a hinge part therein is disposed between a first housing 51 and a second housing 52, a first circuit board 54 is disposed in the first housing 51, and a second circuit board 55 is disposed in the second housing 52. The third housing 53 is provided with a first hinge part 56 and a second hinge part 57. The first hinge part 56 has a first rotation axis extending along a lateral direction of the housing so as to open and close the housing in a longitudinal direction as shown in this diagram. The second hinge part 57 has a second rotation axis extending along the longitudinal direction of the housing so as to open and close the housing in the lateral direction. The first hinge part 56 couples the second housing 52 and the third housing 53, and can rotate the first housing 51 and the third housing 53 about the first rotation axis with respect to the second housing 52. The second hinge part 57 couples the first housing 51 and the third housing 53, and can rotate the first housing 51 about the second rotation axis with respect to the second housing 52 and the third housing 53. In a side view of FIG. 1(A), the first hinge part 56 and the second hinge part 57 are arranged along an extension in the longitudinal direction of the first housing 51.

In this case, an antenna substrate 59 having an antenna element 58 mounted thereon is disposed in the vicinity of the hinge part within the second housing 52. Although the first hinge part 56 is not illustrated in a plan view of FIG. 1(A), the first hinge part 56 is disposed within the second housing 52 at a position overlapping with the antenna substrate 59 in the plan view. The antenna element 58 is connected to the second circuit board 55 through a power feeding portion 60, and connected to a matching circuit 61 and a radio circuit 62 which are mounted on the second circuit board 55. Also, a connection cable 63 for input or output of signals is inserted into the second hinge part 57. The connection cable 63 includes a plurality of coaxial thin lines, and electrically connects the first circuit board 54 and the second circuit board 55. The connection cable 63 connects signal lines allowing the circuits to function, and the grounds between the first circuit board 54 and the second circuit board 55. The power feeding portion 60 and the connection cable 63 are arranged at a given distance so as not to be close to each other at both ends of the housing in the lateral direction thereof. In this configuration, the antenna element 58 and the first hinge part 56 are first capacitively coupled to each other. The first hinge part 56 and the first circuit board 54 within the first housing 51 are further capacitively coupled to each other. In a state where the housing is opened, the first hinge part 56 and the first circuit board 54 function as an antenna element, and perform dipole operation.

The second example illustrated in FIG. 1(B) is of a reverse hinge structure in which the above first example is modified, and the first housing 51 and the third housing 53 rotate with respect to the second housing 52 in the double-hinged structure. In the second example, a third housing 13 having a hinge part therein is disposed between a first housing 11 and a second housing 12. A first circuit board 14 is disposed on the first housing 11, and a second circuit board 15 is disposed on the second housing 12. A first hinge part 16 having a first rotation axis along the lateral direction of the housing for opening or closing the housing in the longitudinal direction as in a state shown in the figure is disposed on a base end part of the second housing 12 at the third housing 13 side. A second hinge part 17 having a second rotation axis along the longitudinal direction of the housing for opening or closing the housing in the lateral direction is disposed on the third housing 13. The first hinge part 16 couples the second housing 12 and the third housing 13, and can rotate the first housing 11 and the third housing 13 about the first rotation axis with respect to the second housing 12. The second hinge part 17 includes an electrically conductive member, couples the first housing 11 and the third housing 13, and can rotate the first housing 11 about the second rotation axis with respect to the second housing 12 and the third housing 13. In a side view of FIG. 1(B), the first hinge part 16 is arranged along an extension in the longitudinal direction of the second housing 12, and the second hinge part 17 is arranged along an extension in the longitudinal direction of the first housing 11.

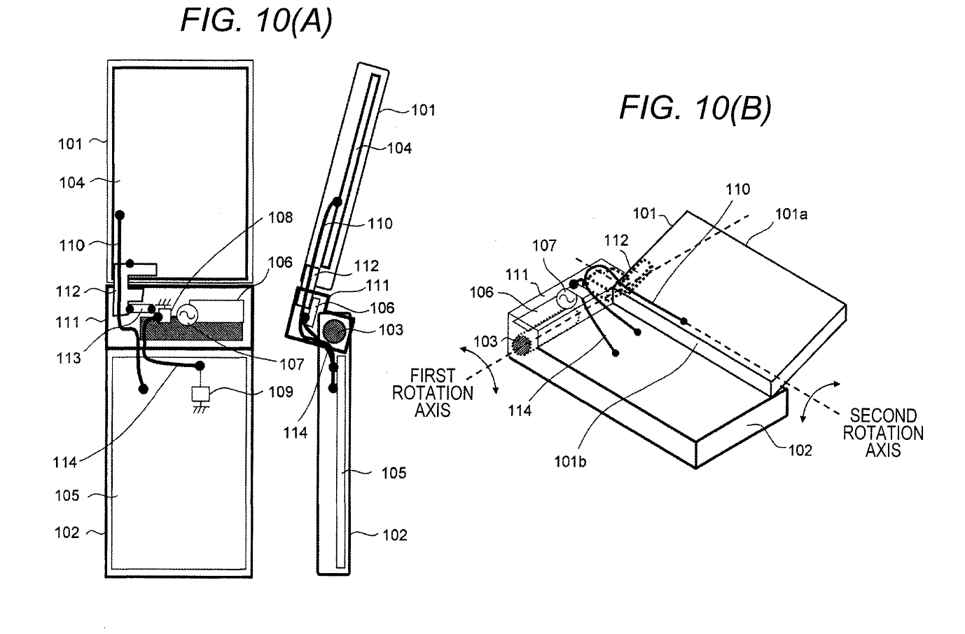

In this case, an antenna substrate 19 having an antenna element 18 mounted thereon is disposed within the third housing 13, and a matching circuit 21 is disposed on the antenna substrate 19. In a plan view of FIG. 1(B), although the first hinge part 16 is not shown, the first hinge part 16 is disposed at a position overlapping with the antenna substrate 19 within the third housing 13 in the plan view. The antenna element 18 is connected to a power feeding portion 20, and connected to a radio circuit 22 mounted on the second circuit board 15 through the matching circuit 21 and an RF cable 29. The ground of the matching circuit 21 is connected to the second hinge part 17 including an electrically conductive member through a connection member 24. The second hinge part 17 is connected to the first circuit board 14 within the first housing 11. The second hinge part 17 functions as the ground of the antenna element 18. Also, a connection cable 23 for input and output of signals are inserted into the second hinge part 17, and the first circuit board 14 and the second circuit board 15 are electrically connected by the connection cable 23. The connection cable 23 includes a plurality of coaxial thin lines, and connects signal lines allowing the circuits to function, and the grounds between the first circuit board 14 and the second circuit board 15. This configuration has the same structural limit as that that described above in FIG. 10(B), and because the power feeding portion 20 is disposed in the vicinity of the second hinge part 17 and the ground of the connection cable 23, this configuration is different from the conventional housing dipole antenna configuration. Also, the connection cable 23 having a different impedance is inserted into the second hinge part which is the ground of the matching circuit, and the respective currents are liable to influence each other.

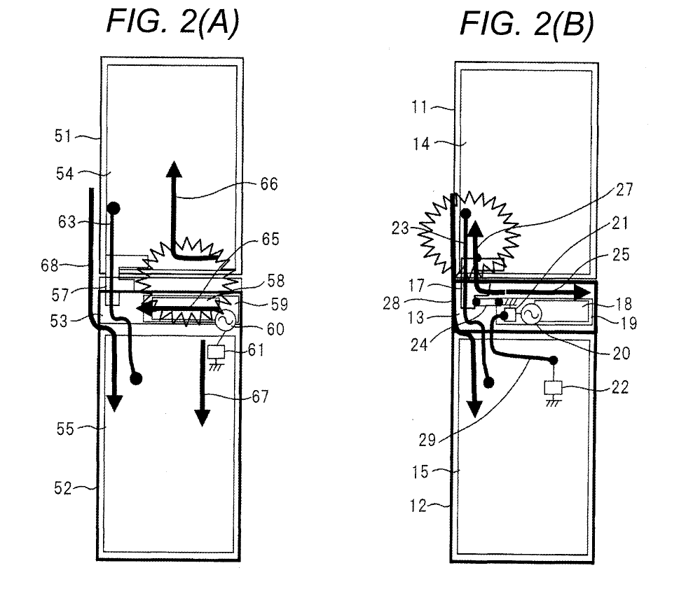

FIG. 2 is diagrams schematically illustrating currents in operation in the configuration examples of the portable radio apparatus illustrated in FIG. 1, in which FIG. 2(A) illustrates a current state in a first example, and FIG. 2(B) illustrates a current state in a second example. In the drawings, most of arrows represent directions along which current flows, and opposite directions represent opposite phases.

As illustrated in FIG. 2(A), in the configuration of the first example, a current 65 flows in the antenna element 58, and the antenna element 58 is capacitively coupled to the first hinge part 56 and the first circuit board 54 whereby a current 66 flows in the first circuit board 54 within the first housing 11. Also, a current 67 flows from the ground of the matching circuit 61 connected to the antenna element 58 to the ground of the second circuit board 55. In the configuration of the first example, because the antenna element 58 is disposed within the second housing 52, a position of the power feeding portion 60 for the antenna element 58 can be relatively freely set, and the power feeding portion 60 can be arranged apart from the connection cable 63. For that reason, the antenna element 58 is hardly affected by a current 68 flowing in the connection cable 63 so that a high radiation efficiency can be obtained. Also, because the second hinge part 57 is not electrically and physically connected to the antenna element 58, an influence of the second hinge part 57 is also low.

On the other hand, as illustrated in FIG. 2(B), in the configuration of the second example, an element current 25 flows in the antenna element 18, and a current 27 flows from the ground of the matching circuit 21 connected to the power feeding portion 20 of the antenna element 18 to the ground of the first circuit board 14 within the first housing 11 through the connection member 24 and the second hinge part 17. Also, a current 18 flows from the first circuit board 14 to the second circuit board 15 in the connection cable 23. In the configuration of the second example, the antenna element 18 is disposed within the third housing 13, resulting in a structural limit that the positions of the first hinge part 16, the second hinge part 17, the antenna element 18, and the power feeding portion 20 are limited as described above in FIGS. 10(A) and 10(B). Because the third housing 13 in which the antenna element 18 is disposed rotates with respect to the second housing 12, the power feeding portion 20 of the antenna element 18 cannot be set at a position apart from the second hinge part 17, and needs to be disposed in the vicinity of the connection cable 23 and the second hinge part 17. For that reason, the power feeding portion 20 is liable to be influenced by the connection cable 23 and the second hinge part 17. Also, in the connection cable 23, a current 28 flowing from the first circuit board 14 to the second circuit board 15 is opposite in phase to a current 27 flowing from the second hinge part 17 to the first circuit board 14, and the currents are cancelled. Therefore, the radiation efficiency is deteriorated.

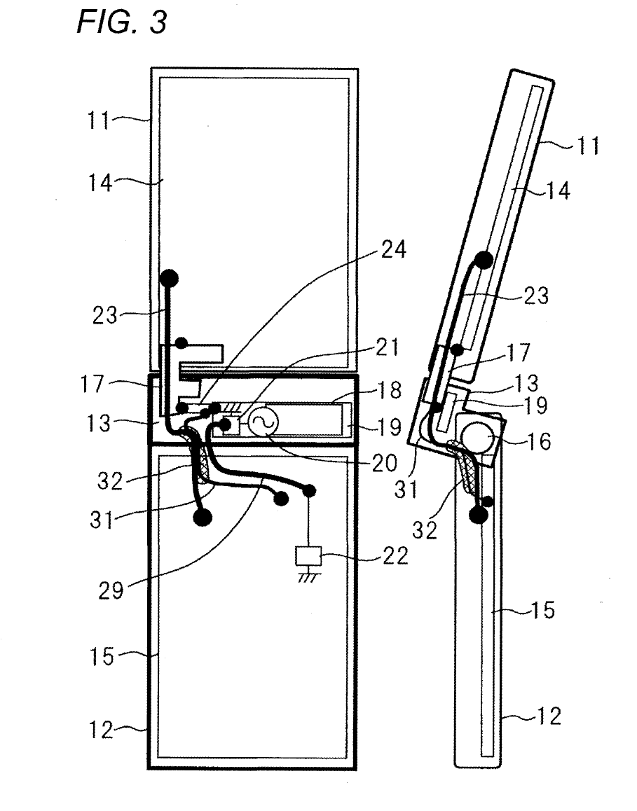

Under the circumstances, in this embodiment, in order to improve the characteristics in the housing configuration as in the above second example, the following components are provided. FIG. 3 is a diagram illustrating a configuration of the portable radio apparatus according to the embodiment of the present invention, which illustrates the housing configuration, the arrangement of the antenna, and the configuration related to the connection of the electrically conductive member. In FIG. 3, a left side is a diagram of the housing viewed from the back side, and a right side is a diagram viewed from the right side of the back side, each schematically illustrating the respective components inside the housing in a viewable manner. The same components as those in FIG. 1(B) are denoted by identical symbols.

In this embodiment, an electrically conductive connection member 31 is disposed, which electrically connects the ground of the antenna element 18 and the ground of the second circuit board 15 within the second housing 12. As the ground of the antenna element 18, any ground path from the antenna element 18 to the second hinge part 17, such as a ground pattern of the antenna substrate 19 on which the antenna element 18 is disposed, the ground of the matching circuit 21 disposed on the antenna substrate 19 within the third housing 13 together with the antenna element 18, or the connection member 24 or the second hinge part 17 connected to the ground of the matching circuit 21, is connected to one end of the electrically conductive connection member 31. The electrically conductive connection member 31 includes a linear-shaped member, and disposed as close as possible to the connection cable 23 along at least a part of the connection cable 23. Further, in the electrically conductive connection member 31, a shield part 32 including a reticulated electrically conductive member for covering at least a partial periphery of the connection cable 23 is provided. In an example of FIG. 3, one end of the electrically conductive connection member 31 is connected to the ground pattern of the matching circuit 21 on the antenna substrate 19, and the other end thereof is connected to the ground pattern of the second circuit board 15. The effect is obtained by only the arrangement of the electrically conductive connection member 31 along the connection cable without provision of the shield part 32.

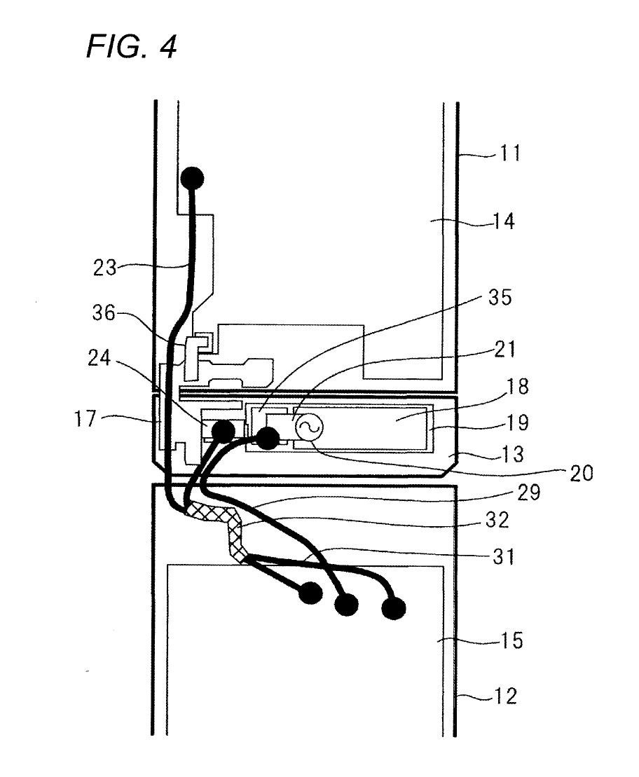

FIG. 4 is a diagram illustrating a main configuration of the portable radio apparatus according to this embodiment, which enlarges a neighborhood of the hinge part in a state where the housing is viewed from the back side.

The antenna substrate 19 disposed within the third housing 13 is formed with the antenna element 18 made by an electrically conductive pattern and a ground pattern 35. Also, the matching circuit 21 is mounted on the antenna substrate 19, and one end thereof is connected to the antenna element 18 through the power feeding portion 20. The ground of the matching circuit 21 is connected to the ground pattern 35. The ground pattern 35 of the antenna substrate 19 is connected to the second hinge part 17 including an electrically conductive metal member through the connection member 24 made of an electrically conductive sheet-metal material. The second hinge part 17 is connected to the ground pattern of the first circuit board 14 within the first housing 11 through a connection member 36 made of the electrically conductive sheet-metal material in the vicinity of an end thereof at the first housing 11 side. Also, the other end of the matching circuit 21 is connected to one end of the RF cable 29 connected with a radio circuit. The other end of the RF cable 29 is connected to the second circuit board 15 within the second housing 12, and connected to the radio circuit mounted on the second circuit board 15. Because a transmission loss is reduced, the RF cable 29 generally includes a coaxial line.

One end of the electrically conductive connection member 31 is connected to any one of the connection member 24, the ground pattern 35 of the matching circuit 21, and the second hinge part 17. The other end of the electrically conductive connection member 31 is connected to the ground pattern of the second circuit board 15. The electrically conductive connection member 31 is disposed close to the connection cable 23 that extends from the first housing 11 through the third housing 13, and is inserted into the second housing 12. A part of the connection cable 23 is covered with the shield part 32 of the electrically conductive connection member 31 so as to be shielded. The shield part 32 includes, for example, a reticulated electrically conductive braided wire configuring a coaxial outer conductor, or a cylindrical metal member. The shield part 32 is a part of the electrically conductive connection member 31, and electrically connected thereto.

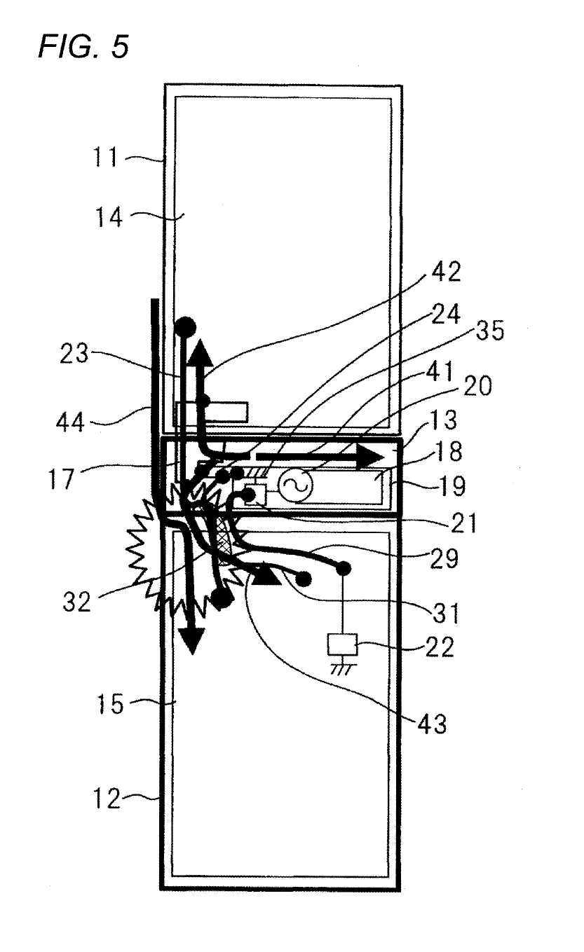

Subsequently, a current in operation according to this embodiment will be described. FIG. 5 is a diagram schematically illustrating currents in operation in the portable radio apparatus according to this embodiment. In the drawing, most of arrows represent directions along which current flows, and opposite directions represent opposite phases.

In this embodiment, an element current 41 flows in the antenna element 18, and a current 42 flows from the ground of the matching circuit 21 connected to the antenna element 18 to the ground of the first circuit board 14 within the first housing 11 through the ground pattern 35, the connection member 24, and the second hinge part 17. Also, a current 43 flows from the ground of the matching circuit 21 to the ground of the second circuit board 15 within the second housing 12 through the electrically conductive connection member 31. Also, in the connection cable 23, a current 44 flows from the first circuit board 14 to the second circuit board 15.

In the configuration of this embodiment, both ends of the electrically conductive connection member 31 are connected to the ground whereby the ground of the matching circuit 21 is also connected to the second circuit board 15. Therefore, the ground of the matching circuit 21 can be enhanced, and the current can be dispersed into those two currents 42 and 43 flowing in a path to the first circuit board 14 and a path to the second circuit board 15 from the second hinge part 17, respectively. In this situation, because the current 42 is smaller in the amount of current than the current 27 in FIG. 2(B), the amount of cancel due to the opposite phase between the current 44 and the current 42 flowing in the connection cable 23 becomes small so that the mutual influence can be reduced. Further, because the current 43 is not opposite in the phase to the current 44, the current that is liable to be concentrated in the neighborhood of the second hinge part 17 can flow in the direction of the second circuit board 15, and be effectively dispersed without mutually canceling those currents.

Also, at least a part of the connection cable 23 is covered with the shield part 32 of the electrically conductive connection member 31, resulting in a structure in which a conductor is further disposed outside the outer conductor of the connection cable 23. A coaxial structure having the connection cable 23 as a center conductor and the shield part 32 of the electrically conductive connection member 31 as an outer conductor is formed. In this case, the connection cable 23 and the electrically conductive connection member 31 are coupled with each other. As a result, a current flowing in the connection cable 23 is reduced, a larger amount of current flows in the electrically conductive connection member 31, and positively flows to the ground of the second circuit board 15 whereby the opposite phase currents of the current 42 flowing into the first circuit board 14 and the current 44 in the connection cable 23 can be suppressed. In this way, the shield part 32 covering the periphery of the connection cable 23 is arranged, and both ends of the electrically conductive connection member 31 are connected to the ground whereby the effect of shielding the connection cable 23 can be enhanced, and the unnecessary radiation from the connection cable 23 can be suppressed. The shield part 32 covers the connection cable 23 between the second hinge part at the second circuit board 15 side and the second circuit board as much as possible, thereby obtaining the high shield effect. Also, one connection portion of the electrically conductive connection member 31 is any one of the ground pattern 35 of the antenna substrate 19, the connection member 24, and the second hinge part 17, which is the ground of the antenna element. The higher improvement effect is obtained as the connection portion is closer to the second hinge part.

Further, in a calling state using a cellular phone function, the user grasps the portable radio apparatus, positions the apparatus in the vicinity of his head, and brings a receiver disposed in the housing in close contact with his ear. In this situation, the effect of improving an SAR (specific absorption rate) can be obtained. As described above, in this embodiment, a current flowing in a path from the second hinge part 17 close to the head in the calling state to the first circuit board 14 is also allowed to flow in a path to the second circuit board 15, which is located apart from the head, and dispersed by the electrically conductive connection member 31. As a result, radiation in the vicinity of the second hinge part 17 is reduced, and the SAR is improved.

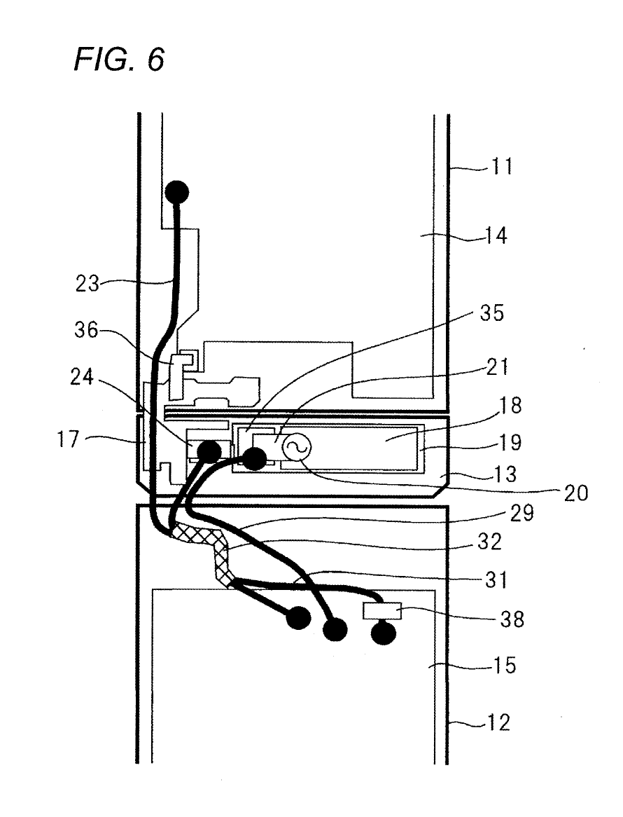

FIG. 6 is a diagram illustrating a configuration of a portable radio apparatus according to a second embodiment of the present invention. In the second embodiment, an adjustment element 38 having a given impedance, which is configured by an inductor and a capacitor, is arranged on a connection portion of the electrically conductive connection member 31 at the second circuit board 15 side. The other configurations are identical with the configurations of this embodiment illustrated in FIG. 4. The adjustment element 38 is configured by, for example, a parallel resonance circuit of the inductor and the capacitor. The impedance of the electrically conductive connection member is appropriately set by adjustment of the respective values to change the connection condition of the ground and adjust the amount of current. Thus, the ground states of the antenna element 18 and the second circuit board 15 are optimized. The adjustment element having a given impedance, which is configured by the inductor and the capacitor, is disposed on any ground connection portion of a path connected to the ground of the first circuit board 14 from the second hinge part 17 through the connection member 36. As a result, the amount of current flowing in this path can be adjusted.

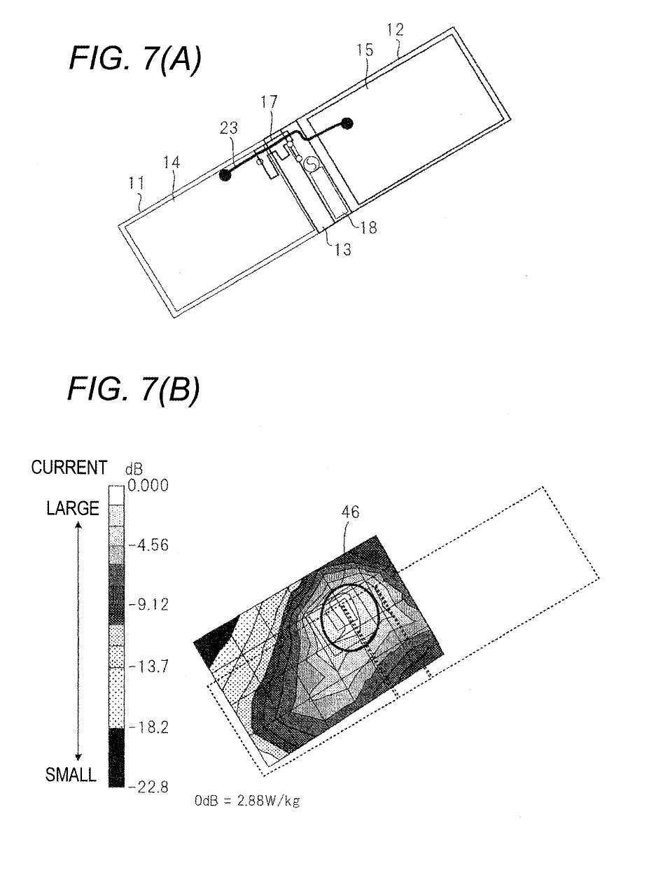

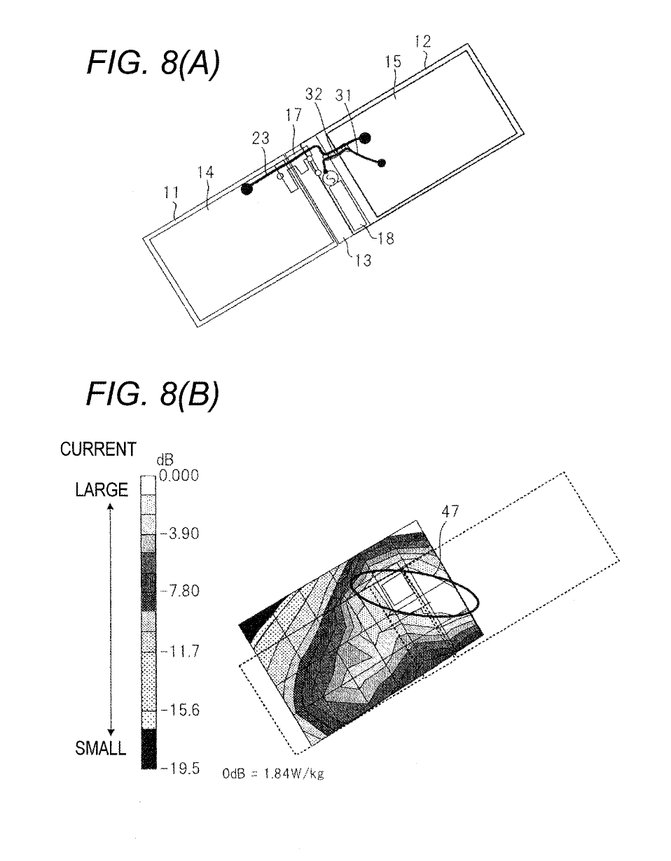

A measurement example of the SART will be described below as an example of this embodiment. FIG. 7 is diagrams illustrating a measurement example of the SAR in a comparative example in which no electrically conductive connection member is provided. FIG. 7(A) illustrates an arrangement state of the housing, and FIG. 7(B) illustrates a measurement result of the SAR. FIG. 8 is diagrams illustrating a measurement example of the SAR in this embodiment in which an electrically conductive connection member is provided. FIG. 8(A) illustrates an arrangement state of the housing, and FIG. 8(B) illustrates a measurement result of the SAR. In both of the comparative example of FIG. 7 and this embodiment of FIG. 8, a measurement frequency is set to 1980 MHz. Both of FIG. 7(A) and FIG. 8(A) illustrate a state in which the housing is viewed from a front side, in which the first housing 11 is disposed at the lower left side, the second housing 12 is disposed at the upper right side, and the second hinge part 17 is disposed in the upper center portion.

As illustrated in FIG. 7(B), in the comparative example in which no electrically conductive connection member is provided, a current is concentrated in a portion of the second hinge part 17 in a narrow range close to the third housing 13, which is surrounded by an ellipsoid 46. On the contrary, as illustrated in FIG. 8(B), in this embodiment in which the electrically conductive connection member is provided, a current is dispersed to the second circuit board 15 side along the second hinge part 17 and the electrically conductive connection member 31 in a wide range extending from the third housing 13 to the second housing 12, which is surrounded by a horizontally long ellipsoid 47. In the comparative example of FIG. 7, the SAR having an average of 10 g is 1.42 W/kg, and in this embodiment of FIG. 8, the SAR having an average of 10 g is 0.987 W/kg. As in this measurement example, with the provision of the electrically conductive connection member, a remarkable improvement effect of about 30% in the SAR is obtained.

As described above, according to this embodiment, the current is dispersed to two paths consisting of a path from the second hinge part 17 to the first circuit board 14 and a path to the second circuit board 15 through the electrically conductive connection member 31 by the electrically conductive connection member 31. As a result, the current that is liable to be concentrated in the vicinity of the second hinge part 17 can be dispersed, and an influence of the current flowing in the connection cable 23 can be reduced. Also, the current flowing in the connection cable 23 flows from the electrically conductive connection member 31 to the second circuit board 15, and the opposite phase currents of the current flowing into the first circuit board 14 and the current flowing in the connection cable 23 can be suppressed. Also, the current that is concentrated in the vicinity of the second hinge part 17 is dispersed by the electrically conductive connection member 31, and the current flows in the direction of the second circuit board 15 located apart from the head of the user in use whereby the SAR can be improved. Also, at least a part of the connection cable 23 is covered with the shield part 32 of the electrically conductive connection member 31 whereby the current flowing in the connection cable 23 flows in the electrically conductive connection member 31, and the current in the connection cable 23 can be suppressed. Further, the effect of shielding the connection cable 23 can be obtained by the shield part 32, and unnecessary radiation from the connection cable 23 can be suppressed.

The present invention is not limited to the above embodiments, but modifications and applications by an ordinary skilled person on the basis of the disclosure of the present specification and known techniques are intended by the present invention, and included in a scope to be protected. Also, the respective components in the above embodiments may be arbitrarily combined together without departing from the subject matter of the present invention.

The present invention is based on Japanese Patent Application No. 2008-280231 filed on Oct. 30, 2008, and contents thereof are incorporated herein by reference.

### INDUSTRIAL APPLICABILITY

The present invention has an advantage that the antenna performance can be improved when the housing is of a double-hinged structure, and the antenna element is arranged within the hinge part, and is useful as the portable radio apparatus having the antenna mounted in the foldable housing.

### DESCRIPTION OF REFERENCE SIGNS

11 first housing
12 second housing
13 third housing
14 first circuit board
15 second circuit board
16 first hinge part
17 second hinge part
18 antenna element
19 antenna substrate
20 power feeding portion
21 matching circuit
22 radio circuit
23 connection cable
24 connection member
25 RF cable
31 electrically conductive connection member
32 shield part
35 ground pattern
36 connection member

1. A portable radio apparatus comprising:
a first housing;
a first circuit board disposed within the first housing;
a second housing;
a second circuit board disposed within the second housing;
a radio circuit disposed on one of the first circuit board and the second circuit board;
a third housing disposed between the first housing and the second housing;
a first hinge part which couples the first housing and the third housing so as to be rotatable about a first rotation axis;
a second hinge part which couples the second housing and the third housing so as to be rotatable about a second rotation axis perpendicular to the first rotation axis, which comprises an electrically conductive member, and which is hollow;
a connection cable which is inserted into the second hinge part, and which electrically connects the first circuit board and the second circuit board; and
an antenna element disposed within the third housing,
wherein the antenna element and the second hinge part are connected such that the second hinge part functions as a ground of the antenna element, and
wherein the portable radio apparatus further comprises an electrically conductive connection member electrically connecting the ground of the antenna element and a ground of the second circuit board.

2. The portable radio apparatus according to claim 1,
wherein the electrically conductive connection member has a linear-shaped member, and is disposed close to and along at least a part of the connection cable.

3. The portable radio apparatus according to claim 1,
wherein the electrically conductive connection member covers at least a periphery of a part of the connection cable.

4. The portable radio apparatus according to claim 1,
wherein an adjustment element configured to adjust a connection condition of the ground and is arranged on a connection portion of the electrically conductive connection member on a second circuit board side.
